(19) United States
(12) Patent Application Publication
(10) Pub. No.: US 2009/0269063 A1
(43) Pub. Date: Oct. 29, 2009

(54) Method and apparatus for enabling activation of services via an Optical Network Terminal (ONT)

(75) Inventors: Marc R. Bernard, Miramar, FL (US); David H. Liu, Herndon, VA (US); Douglas A. Atkinson, Ashburn, VA (US); Fung-Chang Huang, Herndon, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/150,312

(22) Filed: Apr. 25, 2008

(51) Int. Cl. H04J 14/00

(52) U.S. Cl. 398/66

(57) ABSTRACT

Cell phones or other wireless devices are becoming increasingly more accessible to customers, but cell phone features are primarily focused on communications services. A system employing an example embodiment activates services for an Optical Network Terminal (ONT) in the presence of wireless devices. In particular, the ONT responds to a ranging request from an Optical Line Terminal (OLT) with an ONT Identifier (ID) and an ID of a wireless device. If the ID of the wireless device is known, the ONT may enable activate a service, such as a security service for a homeowner. If the ID of the wireless device is unknown, the system may employ security measures, such as notifying the homeowner that a person with a wireless device having an unknown ID is on the premises. Thus, the example embodiment enables or disables premises security or other security based on the ID of the wireless device.

### BACKGROUND OF THE INVENTION

Today, wireless devices, such as cell phones, are becoming increasingly more accessible to customers. In fact, studies show the wireless penetration rates are to surpass 100% soon. That is, each person will own at least one cell phone soon. As the number of cell phones grows, features for cell phones are also developing.

### SUMMARY OF THE INVENTION

A method or corresponding apparatus in accordance with an example embodiment of the invention provides enabling activation of services via an Optical Network Terminal (ONT). In particular, the ONT responds to a ranging request, from an Optical Line Terminal (OLT), with an ONT identifier and an ID of a wireless device, where the wireless device is associated with access to at least one service via the ONT. The ONT enables activation of at least one service if the ID of the wireless device is a known ID.

A method or corresponding apparatus in accordance with another example embodiment of the invention provides a security response to an agent of an Optical Network Terminal (ONT). In particular, the ONT enables responding to a ranging request based on presence of a wireless device with an unknown ID of the wireless device. Further, the ONT sends a response to an agent of the ONT. In this way, the ONT notifies the agent of the presence of the unknown ID of the wireless device on a premises (e.g., a possible intruder on the agent's property).

A method or corresponding apparatus in accordance with yet another example embodiment of the invention provides a wireless user with access point service. In particular, a service provider contracts with customers having an Optical Network Terminal (ONT), configured to support services at a premises, to activate at least one service in the presence of a wireless device with a given device ID. In exchange for enabling activation of at least one service in the presence of the wireless device with the given ID, the service provider collects a fee from the customers.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 depicts a block diagram of a Passive Optical Network (PON) to enable activation of services via an Optical Network Terminal (ONT) according to an example embodiment of the invention;

FIG. 2 is a flow diagram illustrating a procedure to enable activation of services via an Optical Network Terminal (ONT) according to an example embodiment of the invention;

FIG. 3 is a block diagram depicting an Optical Network Terminal (ONT) using a femtocell to detect a wireless device for use in determining activation of service for a Customer Premises Equipment (CPE) according to an example embodiment of the invention;

FIG. 4A is a block diagram depicting a Passive Optical Network (PON) to enable or disable provisioning between an Optical Network Terminal (ONT) and an Optical Line Terminal (OLT) based on whether a ID of a wireless device is known or unknown according to an example embodiment of the invention;

FIG. 4B is a block diagram depicting a Passive Optical Network (PON) having an Optical Network Terminal (ONT) communicating with a database to determine whether an ID of a wireless device is known or unknown according to an example embodiment of the invention;

FIG. 5 is a flow diagram illustrating a procedure to provide a security response to an agent of an Optical Network Terminal (ONT) according to an example embodiment of the invention; and

FIG. 6 is a block diagram depicting a communications network for a service provider to enable activation of services to a customer in exchange for a fee according to an example embodiment of the invention.

### DETAILED DESCRIPTION OF THE INVENTION

A description of example embodiments of the invention follows.

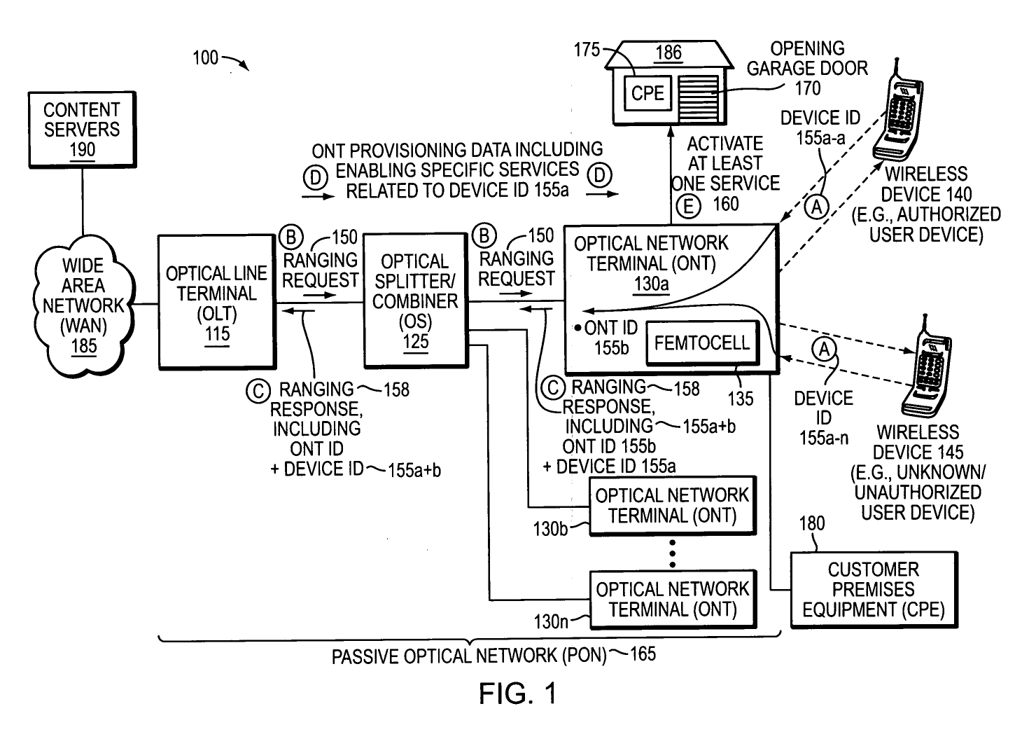

FIG. 1 depicts a block diagram 100 of a Passive Optical Network (PON) 165 to enable activation of services via an Optical Network Terminal (ONT) 130a-n according to an example embodiment of the invention. A PON 165, such as the one presented in FIG. 1, includes optical fiber cabling to carry optical signals to one or more end users. Depending on where the PON 165 terminates, the PON 165 can be described as Fiber-To-The-Curb (FTTC), Fiber-To-The-Building (FTTB), or Fiber-To-The-Home (FTTH), or, more generally Fiber-To-The Premises (FTTP) or Fiber-To-The-X (FTTX). In the example embodiment, the PON 165 may include one or more Optical Line Terminals (OLTs), such as OLT 115, typically located at a central office (not shown) supported by a service provider, and one or more Optical Network Terminals (ONTs) 130a-n. The ONTs 130a-n are generally installed at a user's premises 186 and supports downstream and upstream communications from/to the OLT 115 at the central office to provide communication services for customers of the service provider.

In an example embodiment, the ONT 130a communicates with the OLT 115 via an Optical Splitter/Combiner (OSC) 125. The communications between the OLT 115 and the ONT 130a occur using a downstream wavelength, such as 1490 nanometers (nm), and an upstream wavelength, such as 1310 nm.

In normal operations, before upstream communications from the ONT 130a to the OLT 115 can occur, a ranging request 150 is sent by the OLT 115 to the ONT 130a. The ONT 130a responds to the ranging request 150 with a ranging response 158. Thereafter, the OLT 115 or other supervisory node calculates an equalization delay that is used by the ONT 130a to know when within a communications cycle the ONT 130a can transmit upstream communications, which will be relative to the other ONTs 130b-n also in communication with the OLT 115.

According to an example embodiment of the present invention, extra information, such as an identifier associated with a wireless device, can be included with the ranging response 158 for various purposes, such as enabling or disabling services and security (e.g., intruder alarming).

In a convenient embodiment, the ONT 130a communicates with one or more wireless devices 140, 145, via a femtocell 135, to enable activation of at least one service at one or more Customer Premises Equipment (CPE) 175, 180. The ONT 130a enables activation of at least one service using information relating to whether an ID of the wireless devices 140, 145 is known. The femtocell 135 communicates with the wireless devices 140, 145 via a wireless connection. Using the connection, the femtocell 135 detects a presence of a wireless device, such as wireless devices 140, 145, and an ID of the wireless devices 140, 145. It should be understood that the ONT 130a may have an integrated (or plugged-in) femtocell 135 (or similar wireless/cellular) technology.

In one example embodiment, the femtocell 135 is an Access Point Base Station or, more generally, an access point access network node that is a scalable, multi-channel, two-way communication device. A typical example of a femtocell 135 is a Universal Mobile Telecommunications System (UMTS) access point base station containing a Node-B, Radio Network Controller (RNC) and may use a Wireless Fidelity (WiFi) communications protocol.

In an example embodiment, the femtocell 135 facilitates enabling activation of at least one service via the ONT 130a if the ID 155a-a, 155a-u of a wireless device 140, 145 is known. In particular, when a wireless device 140, 145 comes within the femtocell's 135 range (e.g., the femtocell detects the presence of the wireless device), the femtocell 135 detects the wireless device 140 and obtains the ID 155a-a of the wireless device 140. For example, as a person travels towards a premises 186 with the wireless device 140 (e.g., a cell phone), the femtocell 135 detects the presence of the wireless device 140. Further, the femtocell 135 also obtains the ID 155a-a of the wireless device 140, which the femtocell 135 then provides to the ONT 130a. Using the ID 155a-a of the wireless device 140, the ONT 130a determines an ID status indicating whether the ID 155a-a of the wireless device 140 is known or unknown. To determine the status, the ONT 130a may perform a database query itself or send the ID 155a-a upstream to the OLT 115 to have it perform a database query or send the ID further to a management node, such as an Element Management System (EMS) (not shown) to have it perform the database query.

Based on the ID status (i.e., whether the ID is a known or an unknown ID to the ONT 130a or the PON 165, the ONT 130a may enable activation of or disable at least one service to the ONT 130a or disable upstream communications connectivity of the ONT 130a from the PON 165. For example, the femtocell 135 may detect the ID 155a-a of the wireless device 140. After detecting the ID 155a-a of the wireless device 140, the femtocell 135 provides the ONT 130a with the ID 155a-a. Next, the ONT 130a may respond to a ranging request 150 from the OLT 115, via the OSC 125, and provides the ID 155a-a of the wireless device 140 and an ONT ID 155b to the OLT 115 as part of a ranging response 158. After receiving the ranging response 158, the OLT 115 provisions the ONT 130a, which includes enabling services related to the wireless device ID 155a.

To ensure upstream communications between the ONT 130a and the OLT 115 do not “collide,” ranging is performed. Results of ranging the ONT 130a by the OLT 115 include upstream timing offsets, which are provided to the ONT 130a for use in identifying how long to wait after receipt of a downstream start-of-frame signal (not shown). For example, following detection of a wireless device, the ONT 130a waits for a prescribed upstream timing, with offset, before transmitting upstream as part of a ranging response 158 to establish provisioning. In one embodiment, provisioning allows the ONT 130a to communicate over WAN 185 to content servers 190. Thus, the ONT 130a can send requests for channels associated with content servers 190, and other suitable requests after ranging/provisioning. It should be understood that ranging may occur following a power outage, detection of a wireless device 140, 145, a software upgrade, and so forth.

To better understand an example embodiment of the invention, consider the following example. A person or homeowner arrives at a premises 186 having an authorized user device 140 (e.g., a wireless device), which the femtocell.135 detects. Upon detection of the authorized user device 140, the femtocell 135 obtains a device ID 155a-a and provides the device ID 155a-a to the ONT 130a. In turn, the ONT 130a sends the device ID 155a-a and an ONT ID 155b as part of ranging response 158 to an OLT 115. The OLT 115 returns provisioning data to enable services that are associated with the authorized user device 140. After provisioning, the ONT 130a activates the services, such as opening the garage door 170 associated with the authorized user device 140. In this way, the PON 165 provides for services to be activated at the premises 186 by the homeowner's arrival with the authorized user device 140. It should be understood that services may include deactivating an alarm, opening an entry, activating or deactivating at least one utility, activating a router, or enabling or disabling an appliance at a premises 186.

In an alternative embodiment, after a person arrives at a premises 186 or other ONT 130a location with an unknown/unauthorized user device 145, the ONT 130a sends a device ID 155a-u and an ONT ID 155b of the unauthorized user device 145 as part of a ranging response 158 to an OLT 115. Since the ID of the unauthorized user device 145 is unknown, the ONT 130a disables the PON 165 upstream communications connectivity by sending a faulty ranging request 150 to the OLT 115, which causes provisioning to fail and may also send a response or notification to an agent or homeowner of the ONT 130a. A typical response to the agent includes at least one of the following: providing the agent of the ONT 130a with a notification, turning off a network interface of the ONT 130a, disabling a communications service, disabling a services at a predetermined time, activating security services, or performing a combination thereof. In an embodiment, the femtocell 135 or ONT 130a sends a notification to the unknown/unauthorized user device 145, such as the premises 186 is under surveillance or the like. In an embodiment, an operator of the femtocell 135 or ONT 130a can provide a predetermined action(s), such as notifying an unauthorized user device 145 the premises 186 is under surveillance. The predetermined action(s) can be started by an invalid device ID 155a-u or other indications of an unauthorized user. In this way, the ONT 130a provides a security service or notification for the homeowner of the premises 186 based on the presence of an unauthorized user device 145.

In another example embodiment, the ONT 130a maintains upstream communications connectivity to the PON 165, but deactivates at least one service. For example, the ONT 130a may deactivate a service after a given length of time in an absence of a signal associated with the ID 155a-u (e.g., unknown/unauthorized) of the wireless device 145. Further, the ONT 130a may authorize the response at the OLT 115 at least in part based on the ID of the wireless device, authenticate the response at the OLT 115 at least in part based on the ID of the wireless device, and account the response at the OLT at least in part based on the ID of the wireless device.

It should be understood that some example embodiments of the invention can be employed to support multiple types of wireless devices, such as cellular phone handsets, wireless device IDs 140, 145, Wireless Local Loop (WLL) phones, computers with wireless Internet upstream communications connectivity, WiFi, and Worldwide Interoperability for Microwave Access (WiMAX) gadgets. Moreover, some example embodiments of the invention can be employed with the PON 165 using wireless communications technologies, such as Global System for Mobile Communications (GSM), Code Division Multiple Access (CDMA), Wireless Local Loop (WLL), Wide Area Network (WAN), WiFi, WiMAX, and the like. It should be further understood that example embodiments presented herein may support the above listed technologies, other currently available technologies, or later developed technologies. Moreover, the femtocell 135 in the ONT 130a is merely an example for illustrative purposes, and the femtocell 135 can be separate from ONT 130a and employ other embodiments of the present invention. It should be understood that embodiments of the present invention can also use a picocell instead of a femtocell for benefit of having a different range. Using other devices is also possible.

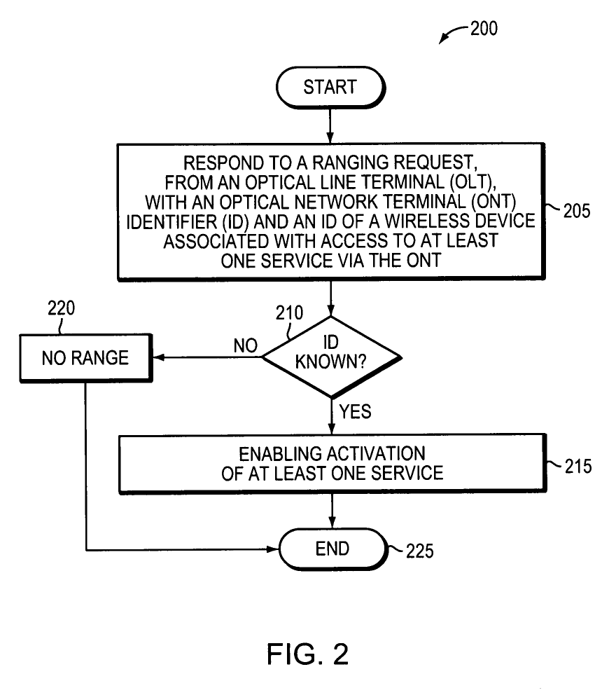

FIG. 2 is a flow diagram illustrating a procedure 200 to enable activation of services via an Optical Network Terminal (ONT) according to an example embodiment of the invention. After beginning, the ONT responds to a ranging request, from an Optical Line Terminal (OLT), with an ONT identifier and an ID of a wireless device associated with access via the ONT (205). If the ID of the wireless device is known (210), the procedure 200 enables activation of at least one service (215). In one embodiment, the procedure 200 detects a presence of the wireless device using the femtocell associated with the ONT and obtains the ID of the wireless device. The procedure 200 responds to the ranging request based on the presence of the wireless device or with the ID along with a ranging response. If the ID of the wireless device is unknown the ONT may restrict access to the ONT, PON, or services (e.g., no ranging or disable service(s)), and the procedure 200 ends (225). It should be understood that the ID of the wireless device may be a serial number (or other unique identifier) of the wireless device. Further, the ID of the wireless device may also be a configured ID, configured username, a password, a Media Access Control (MAC) address, or a combination thereof. It should be further understood that the procedure 200 enables activation if the ONT enters a ranged state for a known wireless device and does not range if the ONT ranging fails due to an unknown wireless device.

In one example embodiment, the ONT may perform a soft hand-off to enable a wireless device to maintain access to communications services, via the ONT, by transferring a connection with a core communications network (not shown) from another wireless communication service point. In an embodiment, the ONT provides a partial soft hand off for security purposes. For example, if the femtocell detects an invalid device ID of a wireless device for an elapsed amount of time, the femtocell allows a partial soft hand-off from the cell-tower to the wireless device for emergency calls (or other identified purposes), but does not allow calls to be made from the wireless device. In turn, the ONT provides the femtocell owner with information relating to the partial soft-hand off. It should be understood that a user of the wireless device would need to go outside of the femtocell range to restore full cellular service. It should be further understood that the femtocell may be configured to always allow emergency calls (e.g., no elapsed time).

Further, the ONT may update a database with a previously unknown ID of the wireless device for a subsequent activation of services based on the ID of the wireless device.

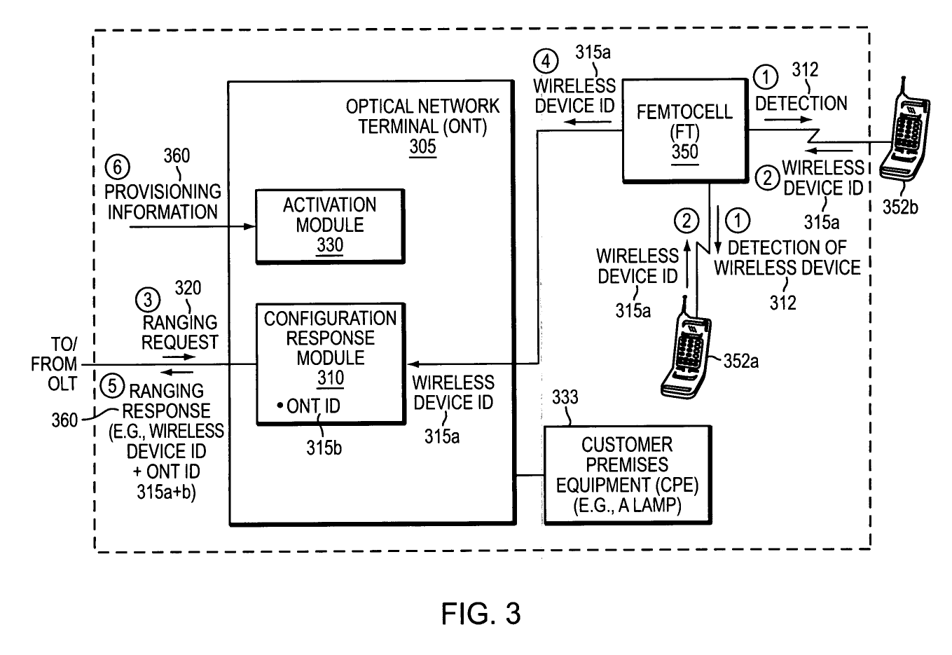

FIG. 3 is a block diagram depicting an Optical Network Terminal (ONT) 305 in communication with a femtocell 350 to activate a service for a Customer Premises Equipment (CPE) 333 according to an example embodiment of the invention. In particular, FIG. 3 shows the ONT 305 communicating with a femtocell 350, CPE 333, and Optical Line Terminal (OLT) (not shown). In the example embodiment, a wireless device, such as wireless device 352a or 352b, is in the presence of the femtocell 350. The femtocell 350 detects the presence of the wireless device 352a or 352b and obtains a wireless device ID 315a, which may be a serial number of the wireless device.

After detecting the wireless device ID 315a, the femtocell 350 sends the wireless device ID 315a to a configuration response module 310 in the ONT 305. The configuration response module 310 sends the wireless device ID 315a and an ONT ID 315b as part of a ranging response 360 upstream to the OLT. In a typical scenario, the ranging response 360 is a communication sent by the ONT 305 to the OLT responsive to a ranging request 320 from the OLT. After ranging, the OLT provisions the ONT and enables activation of at least one service by sending provisioning information 360 with an indication of services to activate, to the activation module 330 in the ONT 305. In turn, the activation module 330 activates the service(s).

For example, the OLT may send the activation module 330 an indication to activate utility services (e.g., water, lights, or sprinkler) and a lamp (e.g., CPE 333). The activation module 330 in turn, for example, turns on a sprinkler and lamp (not shown) at a premises by using a traditional interface(e.g., power line communications) to interact with the service. In this way, the ONT 305 provides non-traditional network services based on a presence of a known wireless device ID. It should be understood that the configuration response module 310 and activation module 330 can be located inside or outside of the ONT 305. Other configurations are also possible.

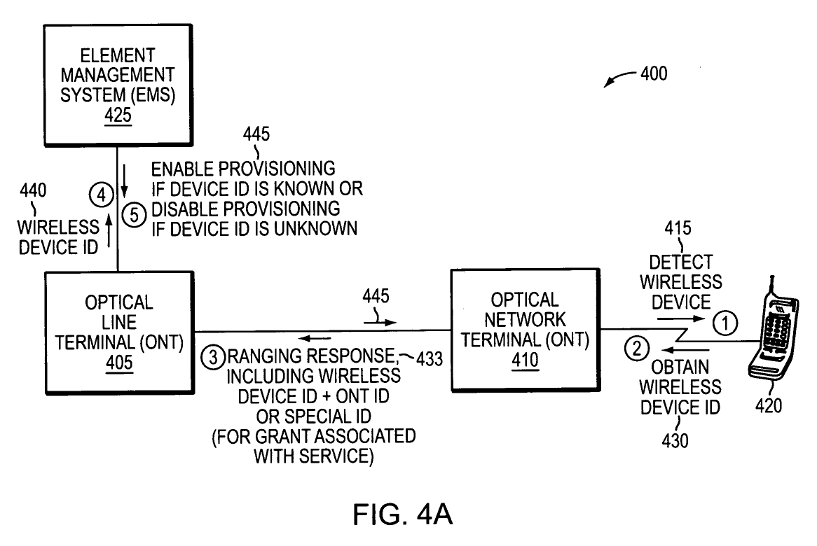

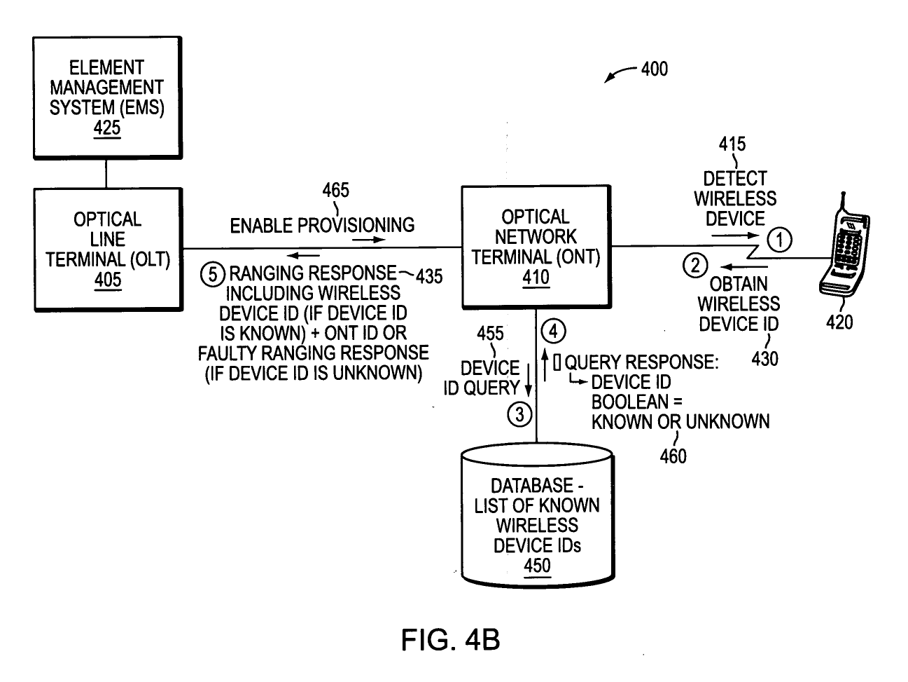

FIG. 4A is a block diagram depicting a Passive Optical Network (PON) 400 to enable or disable provisioning of an Optical Network Terminal (ONT) based on whether a wireless device ID is known or unknown according to an example embodiment of the invention. In particular, in this example, an Optical Network Terminal (ONT) 410 detects a wireless device 420 and obtains the wireless device ID 430. The ONT 410 responds to a ranging request from an Optical Line Terminal (OLT) 405 with a ranging response 433, including the wireless device ID 430 and an ONT ID. The OLT 405 sends the wireless device ID 430 to an Element Management System (EMS) 425. The EMS 425 determines whether the wireless device ID 430 is known or unknown by comparing the wireless device ID 430 with a list of known IDs. The EMS 425 sends instructions 445 to the OLT 405 to enable provisioning if the wireless device ID 430 is known or to disable provisioning if the wireless device 430 is unknown. In turn, the OLT 405 sends the instructions for enabling or disabling to the ONT 410. In an example embodiment, the instructions 445 also include a list of services, and the OLT 405 sends the instructions 445 and list of services to the ONT 410 for activation of services. It should be understood that the OLT 405 or other servers can be used to perform the features of the EMS 425.

In an alternative embodiment, the OLT 405 allows for a ranging request for each service on an ONT 410. In particular, the ONT 410 sends a ranging response 433, including a special ID for a grant message associated with the service, to activate voice service or data transmission for a known wireless device(s). In an embodiment, the special ID of the grant message includes the ID of the wireless device and the service as part of a grant message. After sending the ranging response 433, the ONT 410 requests a ranging timeslot for each device or service. In turn, the OLT 405 sends a grant downstream messages to the ONT 410, which informs the ONTs of a time slot(s). See ITU-T Recommendation G.983. Thus, the ONT 410 obtains a grant on a service or device basis. For each device, the ONT 410 may also include a separate OpenManage Client Instrumentation (OMCI) Management Information Base (MIB) for management of the device. In an embodiment, the OLT 405 provides ranging requests for wavelengths on a Wavelength-Division Multiplexing (WDM) PON. It should be understood that it is possible that separate software images can be downloaded to the same ONT 405 for separate devices or for management of separate devices.

FIG. 4B is a block diagram depicting the PON 400 having the ONT 410 communicating with a database 450 to determine whether an ID of a wireless device is known or unknown according to an example embodiment of the invention. In particular, in this example, the ONT 410 uses a femtocell or picocell to detect a wireless device 415, such as wireless device 420. After detecting the wireless device 420, the ONT 410 obtains a wireless device ID 430 and sends the device ID in a query 455 to the database 450. The database 450 includes a list of known wireless device IDs and responds with a Boolean query response 460 (e.g., 0 or 1). The Boolean query response 460 indicates whether the device ID for the wireless device 420 is known or unknown to the ONT 410.

If the device ID is known, the ONT 410 forwards the device ID of the wireless device 420 and an ONT ID upstream to an Optical Line Terminal (OLT) 405 as part of a ranging response. If the device ID is unknown, the ONT 410 forwards a faulty ranging response or no response to the OLT 405 to prevent ranging or otherwise disable access to services. As a result, the ONT 410 does not connect to the PON 400 and no services or optionally only certain downstream services, are provided to the unknown wireless device. It should be understood that the list of known wireless device IDs in database 450 can be preconfigured, adapted, changed, or modified in any manner or as is suitable to an agent of the ONT 410.

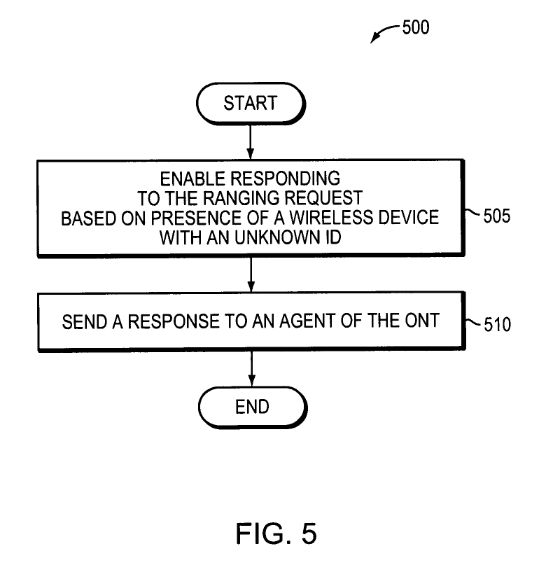

FIG. 5 is a flow diagram illustrating a procedure 500 to provide a security response to an agent of an Optical Network Terminal (ONT) according to an example embodiment of the invention. After beginning, the ONT enables responding to a ranging request based on presence of a wireless device ID with an unknown ID (505). The ranging request is a faulty ranging request to ensure there is no upstream communications connectivity to a Passive Optical Network (PON). Next, the ONT sends a response to an agent of the ONT (510). For example, if a user of a wireless device (with an unknown ID) approaches a premises of the agent of the ONT, the ONT notifies the agent an unknown person is on the premises. Other types of responses include providing the agent of the ONT with a notification via text or other suitable manner, turning off a network interface of the ONT, disabling communications services, disabling services at a predetermined time, activating security services of the premises, or a combination thereof.

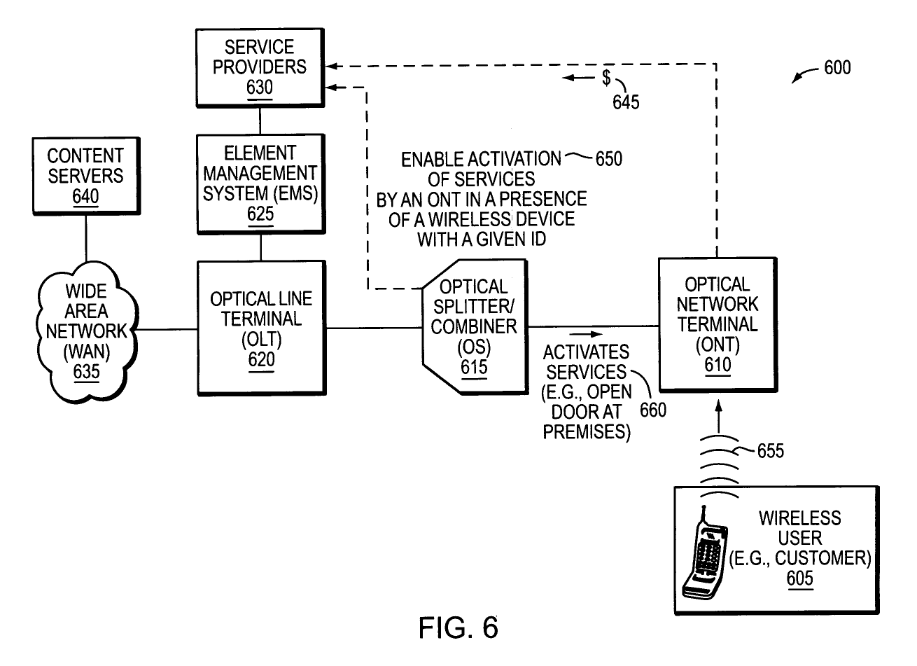

FIG. 6 is a block diagram depicting a communications network 600 for a service provider to enable activation of services to a customer 605 in exchange for a fee according to an example embodiment of the invention. The cellular communications network 600 includes an Optical Network Terminal (ONT) 610, customer 605, Optical Splitter/Combiner (OSC) 615, Optical Line Terminal (OLT) 620, Element Management System (EMS) 625, service providers 630, WAN 635, and content servers 640. In an example embodiment, the ONT 610 detects 655 a wireless user or customer 605 with a wireless device and establishes a connection with the OLT 620, via the OSC 615.

After establishing the connection, the ONT 610 sends a ranging request 650 to enable activation of services in a presence of a wireless device with a given ID (e.g., a known ID) 650. In turn, the service provider 630 activates services 660 via the ONT 610. In exchange for activating the services, the customer 605 makes a payment 645 to the service providers 630.

Alternatively, in exchange for the ONT supporting wireless activation of services, security or other services as a function of wireless devices with known or unknown IDs, the user may have to pay a fee.

It should be understood that example embodiments of the invention can include the EMS 625 managing fee agreements as described below. Further, the communications network 600 can also include a WAN 635 and content servers 640 to allow the ONT 610 to send requests for channels and other suitable requests after ranging/provisioning.

In an example embodiment, the service fee may be a flat fee or a service-per-use fee (reciprocal fee), where a fee is charged by the service providers 630 for activation of service. Further, the fee for the service may be collected on a subscription basis ranging from a one time, daily, weekly, monthly, or annual subscription basis; on a per usage, volume ranges of usage, or rate of usage; invoicing the customer for the fee; or collecting the fee on a prepayment basis. Other arrangements are also possible. Moreover, the service providers 630 may also contract to maintain a centralized database services to activate for a known device IDs.

To establish these types of fee agreements, an ONT 610 or an EMS 625 may perform the appropriate accounting of performance monitoring statistics for traffic, minutes, users, and other relevant data. Specifically, in this example embodiment, a service module or other element of the EMS collects a list of activation of services and provides the statistics to a management element of the EMS. The statistics can be stored in a database or other suitable memory for later review/use.

While this invention has been particularly shown and described with references to example embodiments thereof, it will be understood by those skilled in the art that various changes in form and details may be made therein without departing from the scope of the invention encompassed by the appended claims.

For example, any of the flow diagrams described herein may be modified or arranged in any manner to support operation in various network configurations. The flow diagrams may include more or fewer blocks, combined or separated blocks, alternative flow arrangements, or the like. The flow diagrams may also be implemented in the form of hardware, firmware, or software. If implemented in software, the software may be written in any suitable code in accordance with the example embodiments herein or other embodiments. The software may be stored in any form of computer readable medium and loaded and executed by a general purpose or application specific processor suitable to perform the example embodiments described herein or other embodiments.

What is claimed is:

1. A method of enabling activation of services via an Optical Network Terminal (ONT), comprising:
responding to a ranging request, from an Optical Line Terminal (OLT) with a ranging response, the ranging response including an Optical Network Terminal (ONT) Identifier (ID) and an ID of a wireless device associated with access to at least one service via the ONT; and
enabling activation of the at least one service if the ID of the wireless device is a known ID.

2. The method of claim 1 further including:
detecting a presence of the wireless device using a femtocell associated with the ONT; and
obtaining the ID of the wireless device.

3. The method of claim 1 further including enabling responding to the ranging request based on a presence of the wireless device.

4. The method of claim 1 wherein enabling the activation occurs after the ONT enters a ranged state following the responding to the ranging request and further including entering an unranged state in an absence of the wireless device.

5. The method of claim 1 further including deactivating the at least one service after a given length of time in an absence of a signal associated with the ID of the wireless device.

6. The method of claim 1 further including:
authorizing the response at the OLT at least in part based on the ID of the wireless device;
authenticating the response at the OLT at least in part based on the ID of the wireless device; and
accounting the response at the OLT at least in part based on the ID of the wireless device.

7. The method of claim 1 further including performing a soft handoff to enable the wireless device to maintain access to communications services via the ONT by transfer from another wireless communications service point.

8. The method of claim 1 wherein the at least one service includes at least one of the following services at a premises with which the ONT is associated: deactivating an alarm, opening an entry, activating or deactivating at least one utility, activating a router, or enabling or disabling an appliance.

9. The method of claim 1 further including updating a database with a previously unknown ID of the wireless device for subsequent activation of services based on the ID of the wireless device.

10. The method of claim 1 further including activating the at least one service, via the ONT, to a user of the wireless device.

11. The method of claim 1 wherein the ID of the wireless device is a serial number of the wireless device.

12. An apparatus to enable activation of services via an Optical Network Terminal (ONT), comprising:
a configuration response module to respond to a ranging request from an Optical Line Terminal (OLT) with a ranging response, the ranging response including an Optical Network Terminal (ONT) Identifier (ID) and an ID of a wireless device associated with access to at least one service via the ONT; and
an enabling activation module configured to activate the at least one service, via the ONT, if the ID of the wireless device is a known ID.

13. The apparatus of claim 12 further including a femtocell, associated with the ONT, to detect a presence of the wireless device and obtain the ID of the wireless device for the configuration response module.

14. The apparatus of claim 12 wherein the configuration response module is configured to enable a response to the ranging request based on a presence of the wireless device.

15. The apparatus of claim 12 wherein the configuration response module is configured to enter a state of unranged in an absence of the wireless device.

16. The apparatus of claim 12 further including a deactivation module configured to deactivate the at least one service after a given length of time in an absence of a signal associated with the ID of the wireless device.

17. The apparatus of claim 12 wherein the OLT is configured to:
authorize the response at the OLT at least in part based on the ID of the wireless device;
authenticate the response at the OLT at least in part based on the ID of the wireless device; and
account the response at the OLT at least in part based on the ID of the wireless device.

18. The apparatus of claim 12 further including a soft handoff negotiation module to perform a soft handoff to enable the wireless device to maintain access to communications services via the ONT by transfer from another wireless communications service point.

19. The apparatus of claim 12 wherein the at least one service includes one of the following: deactivate a resident alarm, open a resident entry, enable at least one resident light, activate a resident router, or enable an appliance in the residence.

20. The apparatus of claim 12 further including an update module to update a database with a previously known ID of the wireless device for subsequent activation of at least one service based on the ID of the wireless device.

21. The apparatus of claim 12 wherein the ONT is configured to activate the at least one service to a user of the wireless device.

22. The apparatus of claim 12 wherein the ID of the wireless device is a serial number of the wireless device, configured ID, configured username, a password, Media Access Control (MAC) address, or a combination thereof.

23. A method for providing a security response to an agent, comprising:
enabling responding to a ranging request based on presence of a wireless device with an unknown ID of the wireless device; and
sending a response to an agent of an Optical Network Terminal (ONT).

24. The method of claim 23 wherein the response to the agent includes at least one of the following: providing the agent of the ONT with a notification, turning off a network interface of the ONT, disabling communications service, disabling services at a predetermined time, activating security services, or combination thereof.

25. A method for providing a wireless user with access point service, comprising:
contracting with customers having an Optical Network Terminal (ONT), configured to support services at a premises, to activate at least one service in a presence of a wireless device with a given device ID; and
collecting a fee from the customers in exchange for enabling activation of the at least one service in the presence of the wireless device with the given ID.

26. A method as claimed in claim 25 wherein collecting the fee from the customer includes at least one of the following: collecting the fee on a subscription basis ranging from a one time, daily, weekly, monthly, or annual subscription basis; collecting the fee based on a per usage, volume ranges of usage, or rate of usage; invoicing the customer for the fee; or collecting the fee on a prepayment basis.

27. A method of claim 25 further including contracting to maintain a centralized database of device IDs to activate the at least one service.
